(19) United States
(12) Patent Application Publication
(10) Pub. No.: US 2019/0364537 A1
(43) Pub. Date: Nov. 28, 2019

(54) SYSTEM AND METHOD FOR POSITIONING A TARGET ACCESS POINT

(71) Applicant: BEIJING DIDI INFINITY TECHNOLOGY AND DEVELOPMENT CO., LTD., Beijing (CN)

(72) Inventors: Xianglong NIE, Beijing (CN); Ruidong LI, Beijing (CN); Weihuan SHU, Beijing (CN)

(73) Assignee: BEIJING DIDI INFINITY TECHNOLOGY AND DEVELOPMENT CO., LTD., Beijing (CN)

(21) Appl. No.: 16/532,668

(22) Filed: Aug. 6, 2019

Related U.S. Application Data
(63) Continuation of application No. PCT/CN2017/084876, filed on May 18, 2017.

(51) Int. Cl. H04W 64/00; H04W 4/029

(52) U.S. Cl. CPC H04W 64/003; H04W 4/029

(57) ABSTRACT

Systems and methods for positioning a target access point are disclosed. The method may include obtaining a terminal position for each of a plurality of terminal devices, assigning the respective terminal positions of the plurality of terminal devices as preliminary positions of the target access point, and determining a position of the target access point based on the preliminary positions.

### CROSS-REFERENCE TO RELATED APPLICATIONS

This application is a continuation of International Application No. PCT/CN2017/084876, filed on May 18, 2017, which is incorporated herein by reference in its entirety.

### TECHNICAL FIELD

The present disclosure relates to positioning techniques, and more particularly, to systems and methods for positioning a target access point.

### BACKGROUND

Terminal devices, such as mobile phones, wearables, may be positioned by various positioning techniques, including Global Positioning System (GPS), base stations, Wireless Fidelity (WiFi) access points, and Bluetooth access points. The positioning accuracy is typically less than five meters via GPS, about 100-1000 meters via the base stations, and around 10-50 meters via the WiFi or Bluetooth access points. That is, GPS positioning tends to have a better accuracy in an outdoor environment. However, when the terminal devices receives weak GPS signals or no GPS signals at all (e.g., in an indoor environment), the terminal devices have to be positioned by means of WiFi or Bluetooth access points.

For example, a terminal device may scan nearby access points (e.g., WiFi access points), and determine the distances between the terminal device and each of the access points according to Received Signal Strength Indication (RSSI) of the access points. Based on the distances to the access points and known locations of the access points, the position of the terminal device may be determined. In WiFi or Bluetooth access point based positioning methods, the accuracy of the known positions of the access points plays an important role. Existing methods oftentimes fail to accurately positioning the access points. For example, conventionally, the position of a terminal device may be determined based on GPS signals, and then the position of the terminal device is assigned as the position as an AP close to the terminal device. FIG. 1 is aschematic diagram illustrating a prior art method for positioning an access point. For example, with reference to FIG. 1, a mobile terminal 102 may be carried by a user, who is jogging along a street. An AP 104 (e.g., a WiFi AP) located within a house may be scanned by mobile terminal 102. A positioning server may determine a position of mobile terminal 102 and assign the position of mobile terminal 102 as a position of AP 104. As a result, the position of AP 104 stored in the positioning server may be on the street while the actual position of AP 104 is within the house. Relying on inaccurate positions of the access points to position the terminal devices usually lead to significant errors. For example, a terminal device positioned based on the position of AP 104 may be placed on the street while it is in fact inside a building.

The disclosed systems and methods are directed to improving the accuracy of access point positions.

### SUMMARY

In one aspect, the disclosure is directed to a method for positioning a target access point (AP).

The method may include obtaining a terminal position for each of a plurality of terminal devices; assigning the respective terminal positions of the plurality of terminal devices as preliminary positions of the target access point; and determining a position of the target access point based on the preliminary positions.

In another aspect, the disclosure is directed to a system for positioning a target access point (AP). The system may include a communication interface in communication with a plurality of terminal devices and a positioning server, the communication interface configured to obtain a terminal position for each of the plurality of terminal devices; and a processor configured to assign the respective terminal positions of the plurality of terminal devices as preliminary positions of the target access point, and determine a position of the target access point based on the preliminary positions.

In still another aspect, the disclosure is directed a non-transitory computer- readable medium that stores a set of instructions. The set of instructions, when executed by at least one processor of a positioning system, may cause the positioning system to perform a method for positioning a target access point, the method comprising: obtaining a terminal position for each terminal device; assigning the respective terminal positions of the plurality of terminal devices as preliminary positions of the target access point; and determining a position of the target access point based on the preliminary positions.

It is to be understood that both the foregoing general description and the following detailed description are exemplary and explanatory only and are not restrictive of the invention, as claimed.

### BRIEF DESCRIPTION OF THE DRAWINGS

FIG. 1 is a schematic diagram illustrating a prior art method for positioning an access point.

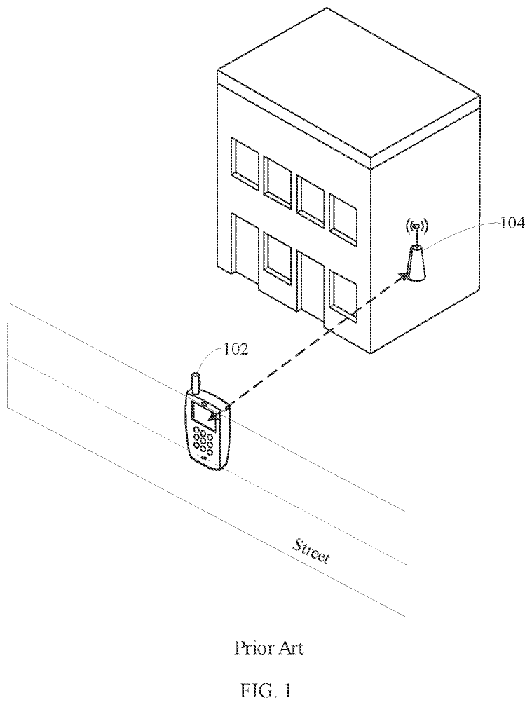

FIG. 2 illustrates a schematic diagram of an exemplary system for positioning a target access point, according to some embodiments of the disclosure.

FIG. 3 illustrates a block diagram of an exemplary system for positioning a target access point, according to some embodiments of the disclosure.

FIG. 4 illustrates a plurality of exemplary preliminary positions for a target AP, according to some embodiments of the disclosure.

FIGS. 5A, 5B, and 5C illustrate exemplary methods for determining center points based on a plurality of preliminary positions for a target AP, according to some embodiments of the disclosure.

FIG. 6 illustrates an exemplary curve of a probability for a cluster to enclose an AP, according to some embodiments of the disclosure.

FIG. 7 is a flowchart of an exemplary method for positioning a target access point, according to some embodiments of the disclosure.

### DETAILED DESCRIPTION

Reference will now be made in detail to the exemplary embodiments, examples of which are illustrated in the accompanying drawings. Wherever possible, the same reference numbers will be used throughout the drawings to refer to the same or like parts.

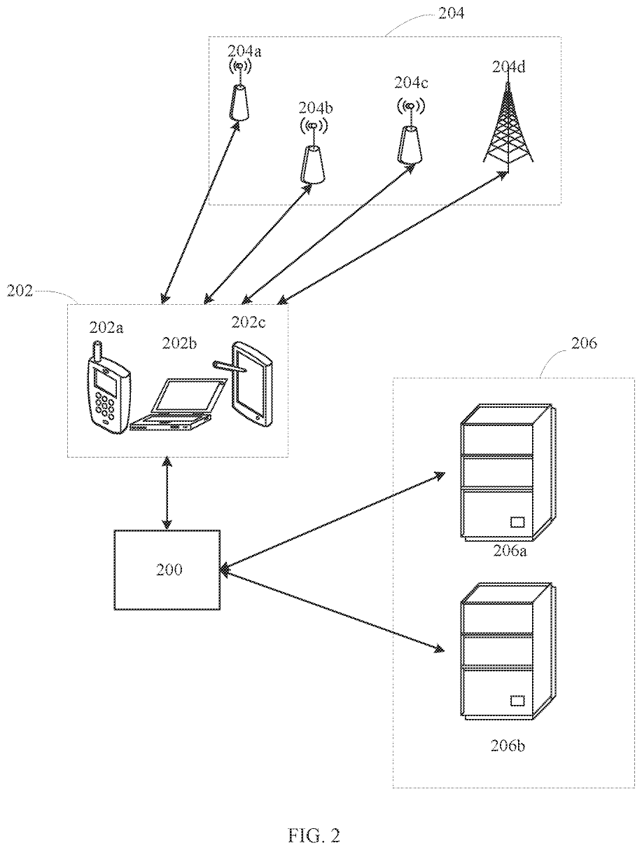

FIG. 2 illustrates a schematic diagram of an exemplary system for positioning a target access point, according to some embodiments of the disclosure. System 200 may be a general server or a proprietary device. Terminal devices 202 may include any electronic device that can scan APs 204 and communicate with system 200. For example, terminal devices 202 may include a smart phone 202a, a laptop 202b, a tablet 202c, or the like.

As shown in FIG. 2, terminal devices 202 may scan nearby APs 204. APs 204 may include devices that transmit signals for communication with terminal devices. For example, APs 204 may include WiFi access points 204a, 204b, and 204c, a base station 204d, Bluetooth access points, or the like. In embodiments of the disclosure, terminal devices 202 may be positioned by WiFi access points. For example, terminal device 202 may receive signals from WiFi APs 204a, 204b, and 204c, for which an AP fingerprint may be generated by each of terminal devices 202. Consistent with the present disclosure, an AP fingerprint may include feature information associated with the APs, such as identifications (e.g., names, MAC addresses, or the like), Received Signal Strength Indication (RSSI), Round Trip Time (RTT), or the like of APs 204. RSSI and RTT can be used to determine distances between a terminal device 202 and each AP 204. The AP fingerprints may be further used for positioning each of terminal devices 202.

The AP fingerprint may be transmitted to system 200 and used to retrieve positions of APs 204 from a positioning server 206. Positioning server 206 may be an integrated part of system 200 or an external server. Positioning server 206 may include a position database that stores positions of APs 204. The position database may store positions of APs 204. In some embodiment, the AP fingerprint may be transmitted to a position database of a first server 206a, and a second server 206b. First and second servers 206a and 206b may belong to different positioning service vendors.

After the AP fingerprints are received, positioning server 206 may determine the positions of terminal devices 202 based on the AP fingerprints and the stored positions of Aps 204. The position of each terminal device 202 can be determined according to, for example, a triangle positioning method, an Angle of Arrival (AOA) method, a Time of Arrival (TOA) method, a Time Difference of Arrival (TDOA) method, or the like. In some embodiments, if a terminal device that scans APs 204 is outdoor, the terminal device may be positioned based on GPS signals.

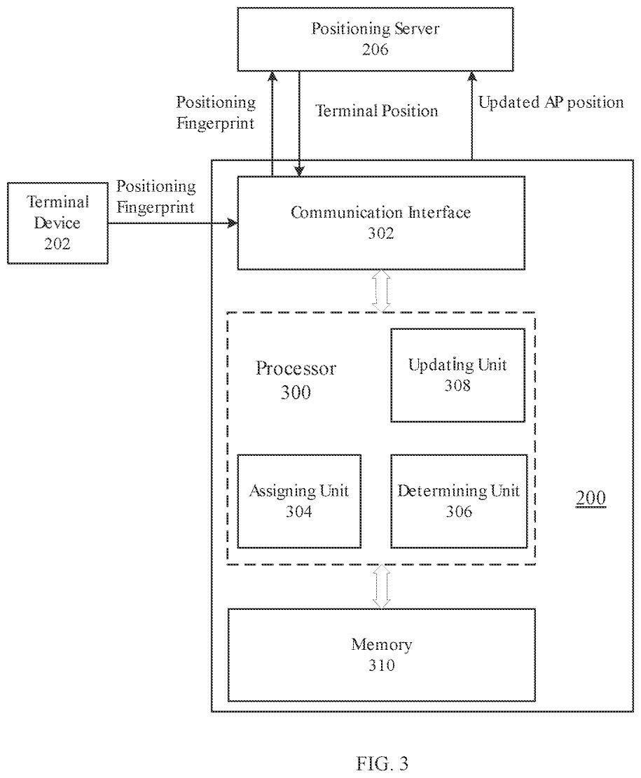

After obtaining a terminal position for each terminal device 202 that scans Aps 204, system 200 may then determine a position of a target AP based on the positions of terminal devices 202. FIG. 3 illustrates a block diagram of an exemplary system for positioning a target access point, according to some embodiments of the disclosure.

As shown in FIG. 3, system 200 may include a communication interface 302, a processor 300 that includes an assigning unit 304, a determining unit 306, and an updating unit 308, and a memory 310. These modules (and any corresponding sub-modules or sub-units) can be hardware units (e.g., portions of an integrated circuit) designed for use with other components or programed (stored on a computer readable medium) to perform a particular function.

Communication interface 302 may be configured to receive an AP fingerprint generated by each of a plurality of terminal devices. For example, each terminal device 202 may generate an AP fingerprint by scanning APs (e.g., APs 204a-d in FIG. 2) and transmit the AP fingerprint to system 200 via communication interface 302. After the AP fingerprints generated by the plurality of terminal devices are transmitted to system 200, communication interface 302 may send the AP fingerprints to positioning server 206, and receive the terminal positions from positioning server 206. As discussed above, positioning server 206 may determine the terminal positions based on the AP fingerprints and stored positions of the APs 204. Therefore, system 200 may obtain a terminal position for each terminal device based on the AP fingerprint. For example, with reference back to FIG. 2, a first terminal position of smart phone 202a and a second terminal position of laptop 202b may both be obtained by system 200.

Because the terminal devices can scan signals of an AP only if the terminal devices are close to the AP, the terminal positions are close to the position of the AP. That is, terminal positions of a plurality of terminal devices scanning a target AP may indicate the position of the target AP. Thus, the position of the target AP may be determined using the terminal positions of the plurality of terminal devices.

In some embodiments, after the terminal positions (e.g., first and second terminal positions) for each of the terminal devices are received by communication interface 302, assigning unit 304 may assign the respective terminal positions of the plurality of terminal devices as preliminary positions of the target access point. For example, the first terminal position may be assigned to APs 204a-c as a first preliminary position for each of APs 204a-c, and the second terminal position may also be assigned to APs 204a-c as a second preliminary position for each of APs 204a-c.

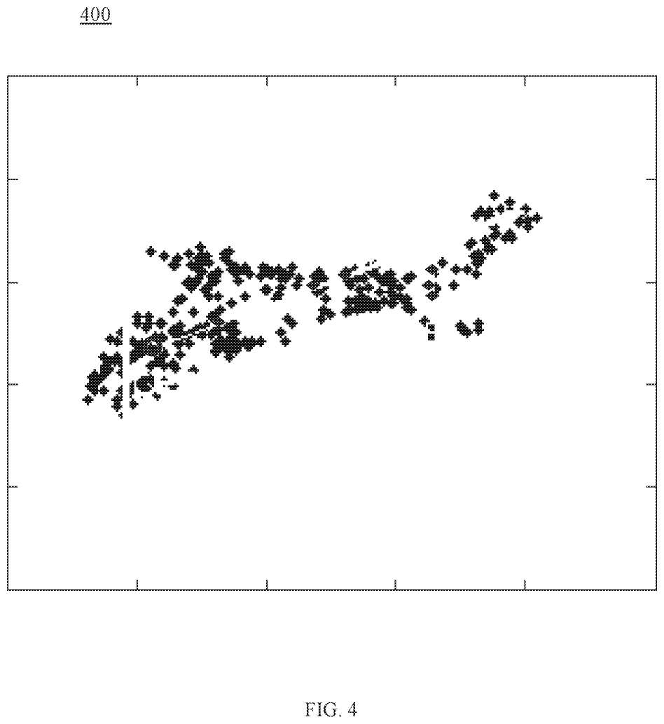

Thus, each AP may have a plurality of preliminary positions corresponding to the positions of the terminal devices scanning the AP. FIG. 4 illustrates a plurality of exemplary preliminary positions for a target AP, according to some embodiments of the disclosure. The target AP can be any one of the APs. As shown in FIG. 4, the plurality of preliminary positions in an area 400 are indicated by black spots. As explained, each preliminary position of the target AP is determined according to the position of the terminal device.

Determining unit 306 may be configured to determine a position of the target access point based on the preliminary positions. For example, determining unit 306 may identify a “center point” of the preliminary positions as the position of the target access point. Consistent with some embodiments, a “center point” is a point within the preliminary position region that has a highest probability to be the real position of the target AP. It is contemplated that, the center point may not necessarily be a point that is centered among the preliminary positions, and may not necessarily overlap with any of the preliminary positions.

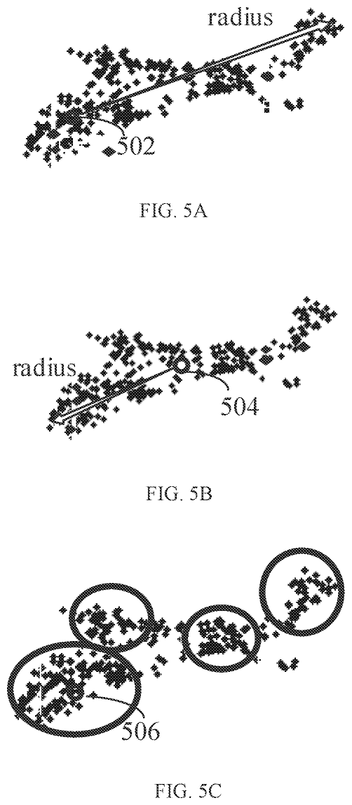

FIGS. 5A, 5B, and 5C illustrate exemplary methods for determining center points based on a plurality of preliminary positions for a target AP, according to some embodiments of the disclosure.

Determining unit 306 may first identify and remove abnormal preliminary positions. As discussed above, each preliminary position may be generated by scanning signals of the APs (including the target AP) by a terminal device. Therefore, each preliminary position is also associated with an AP fingerprint generated by the terminal device, and the AP fingerprint includes feature information of the target AP. For example, a first AP fingerprint generated by smart phone 202a may include feature information indicating a received signal strength of the target AP for the first preliminary position, and a second AP fingerprint generated by laptop 202b may include feature information indicating another received signal strength of the target AP for the second preliminary position.

In one embodiment, if a preliminary position is associated with a received signal strength that is lower than a predetermined threshold value, the preliminary position may be identified as an abnormal preliminary position. The abnormal preliminary position may also include a preliminary position that is geographically abnormal. For example, if one preliminary position is located in New York and the other preliminary positions are all located in Boston, the preliminary position located in New York may be determined as an abnormal preliminary position and removed.

In a first method for determining a center point, after the abnormal preliminary positions have been removed, a preliminary position with a highest density (i.e., density peak) may be determined as the center point. A density of a preliminary position may be calculated by determining the number of preliminary positions within a predetermined area around the preliminary position. In some embodiments, a longest distance between the center point and the preliminary positions may be determined as a distribution radius of the target AP. FIG. 5A shows a center point 502 determined according to the first method described above.

In a second method for determining a center point, after the abnormal preliminary positions have been removed, a median point of the preliminary positions may be determined as the center point by performing statistics on coordinates of the preliminary positions. For example, the X coordinate of the median point is a statistical median value of all X coordinates of the preliminary positions, and the Y coordinate of the median point is a statistical median value of all Y coordinates of the preliminary positions. And a longest distance between the center point and the preliminary positions may be determined as a distribution radius of the target AP. FIG. 5B illustrates a center point 504 determined according to the second method described above.

In a third method for determining a center point, after the abnormal preliminary positions have been removed, all preliminary positions may be classified into clusters based on, for example, a Density Peaks Clustering Algorithm (DPCA). Median points of the clusters may be determined as center points of the cluster.

In one embodiment, determining unit 306 may then determine the median point of a largest cluster as the position of the target AP.

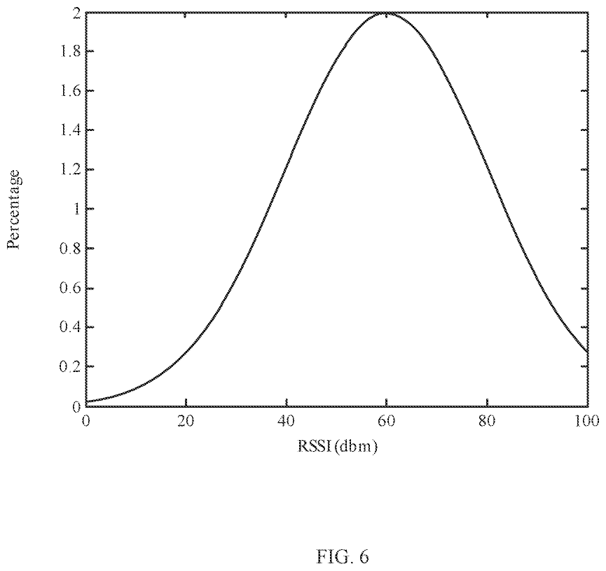

In another embodiment, determining unit 306 may then identify a cluster, among the clusters, that has a highest probability to enclose the target access point, and determine the center point of the identified cluster as the position of the target AP. A probability for a cluster to enclose the target access point may be determined based on strength of received signals of the target access point. FIG. 6 illustrates an exemplary curve of a probability for a cluster to enclose an AP, according to some embodiments of the disclosure. As shown in FIG. 6, the X axis indicates the RSSI, and the Y axis indicates a percentage for a cluster to enclose APs having a specific RRSI. For example, according to FIG. 6, 2% of the APs have an RSSI of 60 dBm. That is, a target AP having a RRSI of, for example, 60 dBm may have a probability of 2% being enclosed by the cluster. Therefore, probabilities for clusters to enclose the target AP may be determined based on the RSSI of the target AP, which may be included in the AP fingerprint. And the center point of the cluster having the highest probability may be the position of the target AP. In some embodiments, the longest distance between the center point of the cluster and the preliminary positions of the cluster may be determined as a distribution radius of the target AP. FIG. 5C illustrates a center point 506 determined according to the third method.

With reference back to FIG. 3, after the position of the target access point has been determined, updating unit 308 may update an existing position of the target access point stored in the position database. As discussed above, the position database may be part of an external positioning server 206 or an internal server of system 200. In one embodiment, updating unit 308 may send to positioning server 206 a request for updating the position of the target access point via communication interface 302. In another embodiment, updating unit 308 may update the position of the target access point to the position database enclosed by a memory 310 of system 200.

Memory 310 may be implemented as any type of volatile or non-volatile memory devices, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, or a magnetic or optical disk. Besides the position database, memory 310 may further store instructions executable by processor 300 of system 200 to cause system 200 to perform functions for determining a position of a target AP.

Processor 300 of system 200, as shown in FIG. 3, may include assigning unit 304, determining unit 306, and updating unit 308 as components.

By means of system 200, the position of the target AP may be determined based on signals received by a plurality of terminal devices from the target AP. As system 200 synthesizes positions of the terminal devices, deviations of the known position of the target AP may be neutralized. Thus, a more accurate position of the target AP may be determined.

As discussed above, system 200 may upload the positions to a position database that stores the positions of the APs. With the improved accuracy of the positions of the APs, positioning for the terminals devices may also be improved. Therefore, by continuously updating the position database, system 200 may continuously improve the positioning for both the Aps and terminal devices.

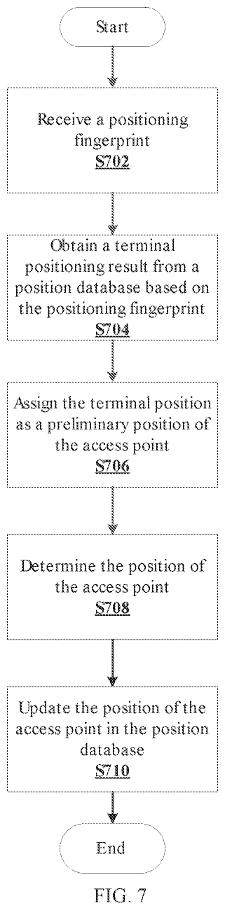

FIG. 7 is a flowchart of an exemplary method for positioning a target access point (AP), according to some embodiments of the disclosure. For example, a method 700 may be performed by system 200, and may include steps S702-S710 discussed as below.

In step S702, system 200 may receive an AP fingerprint generated by each of a plurality of terminal devices. Each of the terminal devices (e.g., a smart phone) may scan several APs to generate the AP fingerprint. The APs may include a Wireless Fidelity access point, a Bluetooth access point, a base station, or the like. Each terminal device may receive signals from the APs, and generate the AP fingerprint respectively. The AP fingerprint may include at least one of identifications of the access points, a Received Signal Strength Indication (RSSI) for each of the access points, or a Round Trip Time (RTT) for each of the access point. In some embodiments, the identifications of the access points may include a name of the AP, a Media Access Control (MAC) address, or the like. The target access point is one of a Wireless Fidelity access point, a Bluetooth access point, or a base station.

In step S704, system 200 may obtain a terminal position for each terminal device. For example, the terminal position may be determined by GPS signals if the terminal device is in an outdoor environment where the GPS signals are available, and the AP fingerprint received in step S702 may be used to determine the terminal position if the GPS signals are not available (e.g., in an indoor environment). Provided with known positions of the scanned APs, the terminal device may be located based on the AP fingerprint. For example, based on the known positions of the scanned APs and received AP fingerprint, the terminal position may be determined by a triangle positioning method, an Angle of Arrival (AOA) method, a Time of Arrival (TOA) method, a Time Difference of Arrival (TDOA) method, or the like.

The known positions of the scanned APs may be stored in a position database. Thus, system 200 may retrieve, from the position database, positions of the scanned access points based on the AP fingerprints, and determine the terminal position based on the retrieved positions and the AP fingerprint. The position database may be an internal database of system 200, or an external database located within a positioning server.

Thus, respective terminal positions of the plurality of terminal devices may be obtained.

In step S706, system 200 may assign the respective terminal positions of the plurality of terminal devices as preliminary positions of the target access point. If a terminal device receives signals from an AP, it indicates the terminal device is close to the AP. Therefore, positions of the terminal device that receive signals from the target access point may be determined as preliminary positions, indicating possible positions of the target access point. A more accurate position of the target AP may be determined from the preliminary positions.

In step S708, system 200 may determine a position of the target access point based on the preliminary positions. For example, system 200 may identify a center point of the preliminary positions as the position of the target access point. In some embodiments, the center point may have a highest probability to be the accurate position of the target AP. It is contemplated that, the center point may not be a point that is physically centered among the preliminary positions, and may not overlap with any of the preliminary positions.

System 200 may identify and remove abnormal preliminary positions. The abnormal preliminary positions may include position(s) that is too far from other preliminary positions or receives very weak AP signals. After the abnormal preliminary positions are removed, the center point may be identified.

In one embodiment, a position with a highest density (i.e., density peak) among the preliminary positions may be determined as the position of the target AP. In another embodiment, a median point of the preliminary positions may be determined as the position of the target AP by performing statistics on coordinates of the preliminary positions. In yet another embodiment, the preliminary positions may be classified into clusters according to, for example, a Density Peaks Clustering Algorithm (DPCA). And system 200 may determine the median point of a largest cluster as the position of the target AP. System 200 may also identify a cluster, among the clusters, that has a highest probability to enclose the target access point, and determine a median point of the identified cluster as the position of the target AP.

In step S710, system 200 may update the position of the target access point stored in the position database. By updating the position of the target access point, stored positions of the access points may be updated by more accurate positions determined by method 700. Thus, positioning for terminal devices may be further improved based on the updated positions of the access points stored in the position database.

Another aspect of the disclosure is directed to a non-transitory computer-readable medium storing instructions that, when executed, cause one or more processors to perform the methods, as discussed above. The computer-readable medium may include volatile or non-volatile, magnetic, semiconductor, tape, optical, removable, non-removable, or other types of computer-readable medium or computer-readable storage devices. For example, the computer- readable medium may be the storage device or the memory module having the computer instructions stored thereon, as disclosed. In some embodiments, the computer-readable medium may be a disc or a flash drive having the computer instructions stored thereon.

It will be apparent to those skilled in the art that various modifications and variations can be made to the disclosed positioning systems and related methods. Other embodiments will be apparent to those skilled in the art from consideration of the specification and practice of the disclosed positioning system and related methods. Although the embodiments are described using WiFi access points as an example, the described systems and methods for positioning a target access point can be applied to any access points, such as Bluetooth access points, base stations, or the like. For example, terminal devices receiving signals from a base station may help with positioning the base station by the systems and methods of the disclosure. It is contemplated that the systems and methods of the disclosure can be applied in an indoor environment or an outdoor environment.

It is intended that the specification and examples be considered as exemplary only, with a true scope being indicated by the following claims and their equivalents.

1. A method for positioning a target access point (AP), comprising:
obtaining a terminal position for each of a plurality of terminal devices;
assigning the respective terminal positions of the plurality of terminal devices as preliminary positions of the target access point; and
determining a position of the target access point based on the preliminary positions of the target access point.

2. The method of claim 1, further comprising:
receiving an AP fingerprint generated by each of the plurality of terminal devices by scanning a plurality of access points.

3. The method of claim 2, wherein the obtaining a terminal position for each of a plurality of terminal devices further comprises:
retrieving, from a position database, positions of the scanned access points according to the AP fingerprint; and
determining the terminal position based on the retrieved positions of the scanned access points and the AP fingerprint.

4. The method of claim 3, further comprising:
updating the position of the target access point stored in the position database.

5. The method of claim 1, wherein the position of the target access point is a position having a density peak among the preliminary positions.

6. The method of claim 1, wherein the determining a position of the target access point further comprises:
classifying the preliminary positions into clusters;
identifying a cluster, among the clusters, that has a highest probability to enclose the target access point; and
determining a median point of the identified cluster as the position of the target access point.

7. The method of claim 6, wherein the preliminary positions are classified into the clusters according to a Density Peaks Clustering Algorithm.

8. The method of claim 6, further comprising:
determining a probability of the target access point being enclosed within each of the clusters based on strength of signals received by the terminal devices.

9. The method of claim 1, wherein the target access point is one of a Wireless Fidelity access point, a Bluetooth access point, or a base station.

10. The method of claim 2, wherein the AP fingerprint comprises at least one of identifications of the access points, a Received Signal Strength Indication (RSSI) for each of the access points, or a Round Trip Time (RTT) for each of the access point.

11. A system for positioning a target access point (AP), comprising:
a communication interface in communication with a plurality of terminal devices and a positioning server, the communication interface configured to obtain a terminal position for each of the plurality of terminal devices; and
a processor configured to
assign the respective terminal positions of the plurality of terminal devices as preliminary positions of the target access point, and
determine a position of the target access point based on the preliminary positions of the target access point.

12. The system of claim 11, wherein the communication interface is further configured to
receive an AP fingerprint generated by each of the plurality of terminal devices by scanning a plurality of access points.

13. The system of claim 12, wherein the communication interface is further configured to:
retrieve, from a position database, positions of the scanned access points according to the AP fingerprint; and
determine the terminal position based on the retrieved positions of the scanned access points and the AP fingerprint.

14. The system of claim 13, wherein the communication interface is further configured to:
update the position of the target access point stored in the position database.

15. The system of claim 11, wherein the position of the target access point is a position having a density peak among the preliminary positions.

16. The system of claim 14, wherein the processor is further configured to:
classify the preliminary positions into clusters;
identify a cluster, among the clusters, that has the highest probability to enclose the target access point; and
determine a median point of the identified cluster as the position of the target access point.

17. The system of claim 16, wherein the preliminary positions are classified into the clusters according to a Density Peaks Clustering Algorithm.

18. The system of claim 16, the processor is further configured to:
determine the probability of the target access point being enclosed within each of the clusters based on strength of signals received by the terminal devices.

19. The system of claim 12, wherein the AP fingerprint comprises at least one of identifications of the access points, a Received Signal Strength Indication (RSSI) for each of the access points, or a Round Trip Time (RTT) for each of the access point.

20. A non-transitory computer-readable medium that stores a set of instructions, when executed by at least one processor of a positioning system, cause the positioning system to perform a method for positioning a target access point, the method comprising:
obtaining a terminal position for each terminal device;
assigning the respective terminal positions of the plurality of terminal devices as preliminary positions of the target access point; and
determining a position of the target access point based on the preliminary positions.
